(19) United States
(12) Patent Application Publication
(10) Pub. No.: US 2010/0119869 A1
(43) Pub. Date: May 13, 2010

(54) HOT-DIPPED ZN-AL-SI-MG-RE STEEL PLATE

(75) Inventor: Xiufei Xu, Zhangjiagang (CN)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: CHANGSHU HUAYE STEEL STRIP CO., LTD, Changshu (CN)

(21) Appl. No.: 12/467,050

(22) Filed: May 15, 2009

(30) Foreign Application Priority Data
Nov. 13, 2008 (CN) 200810235270.5
Feb. 13, 2009 (CN) 200910024773.2

(51) Int. Cl. B32B 15/01

(52) U.S. Cl. 428/659

(57) ABSTRACT

A hot-dipped Zn—Al—Si—Mg—Re steel plate belongs to the technical field of base plate for color coating steel plate, which is characterized in that the composition of the plating layer material on the surface of the hot-dipped Zn—Al—Si—Mg—Re steel plate comprises (by weight) Al 40-45%, Si 1.2-1.4%, Mg 0.5-2.5%, La—Ce mixed Re 0.02-0.10%, and the rest is Zn. The invention has the advantages: (1) minimum plating layer weight per unit area is below 40 g/m², which can save both cost and resource; (2) salt spray test result for incision is 660-680 h under the condition of minimum plating layer weight per unit area (below 40 g/m²), which shows that corrosion resistance is further improved.

### FIELD OF THE INVENTION

The present invention relates to a base plate for color coating steel plate, and particularly relates to a hot-dipped Zn—Al—Si—Mg—Re steel plate.

### BACKGROUND OF THE INVENTION

The available base plates for color coating steel plates in prior arts mainly comprise Zn-plated steel plate, Al-plated steel plate, and alloy-plated steel plate combining the characteristics of both Zn-plated steel plate and Al-plated steel plate. And the alloy-plated steel plate is divided into two types, one is Al—Zn—Si steel plate with 55 wt % of Al in plating layer, and the other is Zn—Al steel plate with 5 wt % of Al in plating layer.

The corrosion resistance of Zn-plated steel plate is worse than that of Al-plated steel plate, while the processability of Al-plated steel plate is worse than that of Zn-plated steel plate. A lot of experiments have been done for achieving both desirable corrosion resistance and processability, i.e. for the complementation of Zn-plating and Al-plating. For example, different Al/Zn ratios have been studied, the mass percentage of Al is increased gradually from 0 to 100%, dip plating temperature is increased gradually from 450° C. to 720° C., and isolation experiments are carried out for corresponding plated products. The result shows that the corrosion resistance of plating layer containing about 5% Al is 2 times as high as that of pure Zn plating layer. But when the mass percentage of Al is within 5-25%, the corrosion resistance of plating layer decreases and is even worse than that of pure Zn plating layer. Then the corrosion resistance of plating layer increases as Al content reasonably increases, i.e. the corrosion resistance of plating layer is 5 times as high as that of pure Zn plating layer. According to the result, American Bethlehem Steel Corp. applied patent application for alloy-plated product having plating layer composed of 55 wt % Al, 43.4 wt % Zn, and 1.6 wt % Si, with commercial name of Galvalume. Later, International Lead and Zinc Research Organization applied patent for alloy-plated product having plating layer composed of 95 wt % Zn, 5 wt % Al, and Re in trace amount, with commercial name of Galfan. The aforementioned information is from “Technical Q&A for Hot-Dip Galvanization of Steel Strip” published by Chemical Industry Press. (2007, edited by Xu Xiufei)

With development of times, steel plates are more frequently made into color coating steel plate after hot-dipped, thus higher performance of base plate of color coating steel plate is required, specifically, it is: flat and smooth plating layer, good bonding between plating layer and coating layer, and excellent protection performance of plating layer for incision. The experiment performed by the inventor according to the aforementioned formula of American Bethlehem Steel Corp. shows that plating bath temperature is as high as 620-650° C., which is not beneficial for energy conservation; the salt spray test result for the incision of color coating steel plate prepared from base plate using the formula is 500 h, which shows the plating has poor protection for the incision; only when the thickness of coat layer exceed 6 μm, crystal flower on surface of hot-dip plating layer can be covered, which is not beneficial for material conservation due to thick coat thickness; as the formula has high Al content (55%), Al in plating bath reacts with iron element on steel sheet surface intensively to generate a large amount of bottom slag, which not only wastes raw material, but also has following shortcomings: (1) production has to be periodically or nonperiodically stopped to collect slag; (2) a large amount of accretion is generated on surface of roller in plating pot, and has to be continuously removed; (3) service life of plating pot inductor is short (barely one year).

With regard to the aforementioned disadvantages, the inventor of the present invention applied patent application of hot-dipped Zn—Al—Si steel plate on Nov. 13, 2008 (with application number of 200810235270.5); the technical scheme of the invention is to select the composition of the plating layer material on surface of the hot-dipped Zn—Al—Si steel plate as: Al 40-45 wt %, Si 1.2-1.4 wt %, and the rest is Zn. Although the technical scheme has the technical effect mentioned in the virtue effect column of page 2 of the Description, it has the disadvantage that the minimum weight of plating layer per unit area is higher; as in real application, even plating layer weight per unit area is already as low as 60 g/m², people still pursues better technical effects; for example, if plating layer weight per unit area can be further lowered in condition that the corrosion resistance may remain unchanged or even be increased, cost and resource can both be saved. Therefore, the formula of the aforementioned patent still can be further improved. The following technical scheme is generated under such background.

### SUMMARY OF THE INVENTION

The object of the present invention is to provide a hot-dipped Zn—Al—Si—Mg—Re steel plate, which has the same or even better corrosion resistance with the minimum plating layer weight per unit area is less than 40 g/m², also can save cost and resources.

The object of the present invention is achieved by a hot-dippped Zn—Al—Si—Mg—Re steel plate which is characterized in that: the plating layer on the surface of said Zn—Al—Si—Mg—Re steel plate is composed of (by weight): Al 40-45%, Si 1.2-1.4%, Mg 0.5-2.5%, La—Ce mixed Re 0.02-0.10%, and the rest is Zn.

Besides having all the merits of the Zn—Al—Si steel plate disclosed in CN 200810235270.5, the technical scheme disclosed in the present invention also has the following advantages: (1) minimum plating layer weight per unit area is below 40 g/m², which can save both cost and resource; (2) salt spray test result for incision is 660-680 h under the condition of minimum plating layer weight per unit area (below 40 g/m²), which shows that corrosion resistance is further improved.

### DETAILED DESCRIPTION OF THE INVENTION

For reducing plating layer weight per unit area, the present invention adopts the method that adding La—Ce mixed Re into plating bath or formula, which can improve the flowability of plating bath, lower surface stress, and improve wetting ability of the plating bath to the base plate; therefore the blow off effect of redundant plating solution by air blade is enhanced, and plating layer weight per unit area is reduced.

For keeping original corrosion resistance after reduction of plating layer weight per unit area, the invention adopts method for adding Mg into plating bath or formula, the result shows that the addition of Mg can separate out Zn—Al—Zn₂Mg ternary eutectics from original Zn—Al binary eutectics, to form mixed tissue of Zn—Al binary eutectics and a small amount of Zn—Al—Zn₂Mg ternary eutectics, which is beneficial for inhibiting oxidation in air. Even oxidation occurs, the generated corrosion product is condensing, and the reaction rate is slow; therefore, corrosion resistance is improved.

Mutual effect of La—Ce mixed Rare earth and magnesium will not weaken their own effect, on the contrary, La—Ce mixed Rare earth improves the flowability of the plating bath, which is more beneficial for uniform distribution of magnesium, and better effect can be achieved.

### Embodiment 1

According to mass percentage, the formula of plating layer composition is aluminum 40% (Al), silicon 1.2% (Si), magnesium 0.5% (Mg), Lanthanum-Cerium (La—Ce) mixed Rare earth 0.02%, and the rest is zinc. The La—Ce mixed Rare earth is preferably selected from but not limited to La—Ce alloy manufactured and sold by TaiZhou YangZiJiang Rare Earth Metals Co, Ltd.

### Application Embodiment 1

On general steel coil continuous hot-dip production line routinely used in prior arts, the chilled steel plate is subjected to degreasing, anneal, and reduction according to hot-dip process requirement, then cooled to 585° C., and introduced into plating bath under oxygen free airproof condition. The formula of plating bath composition is (by mass) Al 40%, Si 1.2%, Mg 0.5%, La—Ce mixed Re 0.02%, and the rest is Zn. The steel plate is plated in the plating bath, and the plating layer attachment amount is controlled to minimum via air blade. The steel plate taken out of the plating bath is rapidly cooled and solidified by air spray cooling to form plating layer with slight crystal grain and flat surface. Then the steel plate is subjected to water quenching, optical finishing, withdrawing straightening, and coiling according to routine hot-dip process to give hot-dipped Zn—Al—Si—Mg—Re steel plate with plating layer on both sides and used as base plate for color coating steel plate (called “color coating base plate” for short). The table 1 shows minimum plating layer weight per unit area and salt spray test result comparison between the hot-dipped Zn—Al—Si—Mg—Re steel plate obtained in embodiment 1 and the Zn—Al—Si plating steel plate disclosed in CN 200810235270.5.

### Embodiment 2

According to mass percentage, the formula of plating layer composition is Al 42.5%, Si 1.3%, Mg 1.5%, La—Ce mixed Re 0.06%, and the rest is Zn. Other matters is same as the description in embodiment 1.

### Application Embodiment 2

On general steel coil continuous hot-dip production line routinely used in prior arts, the chilled steel plate is subjected to degreasing, anneal, and reduction according to hot-dip process requirement, then cooled to 587° C., and introduced into plating bath under oxygen free airproof condition. The formula of the plating bath composition is (by mass) Al 42.5%, Si 1.3%, Mg 1.5%, La—Ce mixed Re 0.06%, and the rest is Zn. The plating bath temperature is controlled at 587° C. The steel plate is plated in the plating bath, and the plating layer attachment amount is controlled to minimum via air blade. The steel plate taken out of the plating bath is rapidly cooled and solidified by air spray cooling to form plating layer with slight crystal grain and flat surface. Then the steel plate is subjected to water quenching, optical finishing, withdrawing straightening, and coiling according to routine hot-dip process to give hot-dipped Zn—Al—Si—Mg—Re steel plate with plating layer on both sides and used as base plate for color coating steel plate. The table 1 shows minimum plating layer weight per unit area and salt spray test result comparison between the hot-dipped Zn—Al—Si—Mg—Re steel plate obtained in embodiment 2 and the Zn—Al—Si plating steel plate disclosed in CN 200810235270.5.

### Embodiment 3

According to mass percentage, the formula of plating layer composition is Al 45%, Si 1.4%, Mg 2.5%, La—Ce mixed Re 0.10%, and the rest is Zn. Other matters is same as the description in embodiment 1.

### Application Embodiment 3

On general steel coil continuous hot-dip production line routinely used in prior arts, the chilled steel plate is subjected to degreasing, anneal, and reduction according to hot-dip process requirement, then cooled to 588° C., and introduced into plating bath under oxygen free airproof condition. The formula of plating bath composition is (by mass) Al 45.0%, Si 1.4%, Mg 2.5%, La—Ce mixed Re 0.10%, and the rest is Zn. The steel plate is plated in the plating bath, and the plating layer attachment amount is controlled to minimum via air blade. The steel plate taken out of the plating bath is rapidly cooled and solidified by air spray cooling to form plating layer with slight crystal grain and flat surface. Then the steel plate is subjected to water quenching, optical finishing, withdrawing straightening, and coiling according to routine hot-dip process to give hot-dipped Zn—Al—Si—Mg—Re steel plate with plating layer on both sides and used as base plate for color coating steel plate. The table 1 shows minimum plating layer weight per unit area and salt spray test result comparison between the hot-dipped Zn—Al—Si—Mg—Re steel plate obtained in embodiment 3 and the Zn—Al—Si plating steel plate disclosed in CN 200810235270.5.

TABLE 1
Performance comparison between embodiment of the present invention
and the Zn—Al—Si plating steel plate disclosed in CN 200810235270.5

| | | | | | Prior Art |
|---|---|---|---|---|---|
| | | | | | (the Zn—Al—Si |
| | | | | | plating steel plate |
| | | | | | disclosed in CN |
| | | | | | 20081023527)0.5 |
| | | | | | (comparison |
| Classification | Index | Embodiment 1 | Embodiment 2 | Embodiment 3 | example) |
| Plating layer | Al (%) | 40 | 42.5 | 45 | 40-45% |
| composition | Si (%) | 1.2 | 1.3 | 1.4 | 1.2-1.4% |
| | Mg (%) | 0.5 | 1.5 | 2.5 | 0 |
| | La—Ce | 0.02 | 0.06 | 0.1 | 0 |
| | mixed Re | | | | |
| | (%) | | | | |
| | Zn (%) | the rest | the rest | the rest | the rest |

| | | | | | | | | |
|---|---|---|---|---|---|---|---|---|
| Minimum plating layer | 39.5 | g/m² | 37 | g/m² | 36 | g/m² | 67.8-82.5 | g/m² |
| weight per unit area | | | | | | | | |
| (both sides) (g/m²) | | | | | | | | |
| Salt spray test for incision | 681 | h | 676 | h | 662 | h | 652-678 | h |
| (h) | | | | | | | | |

1. A hot-dipped Zn—Al—Si—Mg—Re steel plate, characterized in that the plating layer composition on the sheet surface is (by weight) Al 40-45%, Si 1.2-1.4%, Mg 0.5-2.5%, La—Ce mixed Re 0.02-0.10%, and the rest is Zn.
